(19) United States
(12) Patent Application Publication
(10) Pub. No.: US 2017/0021382 A1
(43) Pub. Date: Jan. 26, 2017

(54) MASKING DEVICE

(71) Applicant: Wrensong, LLC, Hartville, OH (US)

(72) Inventor: Robert G. Barton, Hartville, OH (US)

(21) Appl. No.: 15/069,543

(22) Filed: Mar. 14, 2016

Related U.S. Application Data
(60) Provisional application No. 62/132,157, filed on Mar. 12, 2015.

(51) Int. Cl. B05C 21/00; B32B 27/32; B32B 3/16; B32B 27/10; B32B 7/06; B32B 7/12

(52) U.S. Cl. CPC B05C 21/005; B32B 7/06; B32B 7/12; B32B 3/16; B32B 27/10; B32B 27/32

(57) ABSTRACT

A roll, strip, or sheet of masking devices includes a masking device used for painting or other finishing work. Each of the masking devices is configured for masking the surface of an object, such as a windowpane or a corner of a wall adjacent a ceiling. The devices include low tack, pressure sensitive adhesive. The devices can be triangular in shape to provide options for fitting into tight corners. The triangular shape also provides a wide gripping surface for the user's finger and thumb. This makes the triangular masking devices desirable for windows. A gripping tab can be provided along the gripping surface with the gripping tab being free of adhesive for removal.

### CROSS REFERENCE TO RELATED APPLICATIONS

This application claims the benefit of U.S. Provisional Patent Application Ser. No. 62/132,157 filed Mar. 12, 2015, the disclosures of which are incorporated herein by reference.

### BACKGROUND OF THE DISCLOSURE

1. Field of the Disclosure

The disclosure generally relates to masks of the type used to shield surfaces and objects during painting and other finishing procedures. More particularly, the disclosure relates to masking devices that are easy to remove from a package of masking devices, easy to install on the item being masked, and easy to remove from the item being masked. Specifically, the disclosure relates to a removable finishing mask that uses a releasable adhesive to hold the mask to a surface and the triangular body of the mask including a right angle corner for fitting into a corner with the hypotenuses leg having a curve that provides a grip.

2. Background of the Disclosure

Many painters choose to mask corners and lines where an item being painted joins with another item that is not being painted. The masking material is attached to the item that is not to be painted so that the painter does not have to carefully paint an edge line. Instead, the painter covers both the masking material and the surface to be painted. The edge line is formed when the masking material is removed. Windows are commonly masked when painted. The masking material must be fit carefully into each corner of the window in order to prevent paint from contacting the glass. Fitting masking material tightly into each corner can be difficult and time consuming.

### SUMMARY OF THE DISCLOSURE

In one configuration, the disclosure provides a roll, strip, or sheet of masking devices. Each of the masking devices is configured for masking the surface of an object, such as a windowpane or a corner of a wall adjacent a ceiling. The devices include adhesive material that is low tack and pressure sensitive, located on the surface of the mask that faces the object to be masked. The masking devices can be square in shape. The masking devices also can be triangular in shape. The triangular shape makes it easy for the user to fit the right angle of the triangle tightly into a corner being masked. The triangular shape also provides a wide gripping surface for the user's finger and thumb. This makes the triangular masking devices desirable for windows. The triangular shape also provides the two forty-five degree corners for masking tight spots.

The masking devices can be provided in a back-to-back arrangement with their right-angle corners facing away from each other to generally form the shape of a square. The long back edges that are disposed back-to-back can be formed with a protruding tab that provides a grip to the triangle masking device to assist the lifting of the masking device from the release liner. The gripping tab can be formed by defining a portion of the long back edge as a sinusoidal S-curve so that the tabs of the back-to-back triangles complement each other. The gripping tab can also be a blocked sinusoidal shape. The triangles can be spaced apart and surrounded by a border.

The disclosure also provides a mask configuration wherein a fold line is provided through the center of a ninety degree corner of the triangle which is also perpendicular to the hypotenuse. The fold line can be scored to enable the easy folding of the masking body. The folded configuration can be used to mask to wall surfaces below a ceiling.

The masking device triangles can be made from a coated paper material that is resistant to latex and oil paint absorption. The masking device also can be made from a polymer material such as polypropylene. A gloss finish can be applied. An example is a 2.61 pt polypropylene material with 0.95 mil gloss laminate.

The preceding non-limiting aspects, as well as others, are more particularly described below. A more complete understanding of the processes and equipment can be obtained by reference to the accompanying drawings, which are not intended to indicate relative size and dimensions of the assemblies or components thereof. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a plan view of a sheet of masking devices.

FIG. 2 is a plan view of a single square made up of two masking devices disposed back-to-back.

FIG. 3 is a plan view of a strip of masking devices.

FIG. 4 is a front view of a hanger that is used to support a roll of masking devices and to help remove the devices from a release liner.

FIG. 5 is a perspective view of a roll of masking devices carried by the hanger.

FIG. 6 is a plan view of four masking devices that are part of a sheet with gripping tabs projecting from each long back surface.

### DETAILED DESCRIPTION OF THE DISCLOSURE

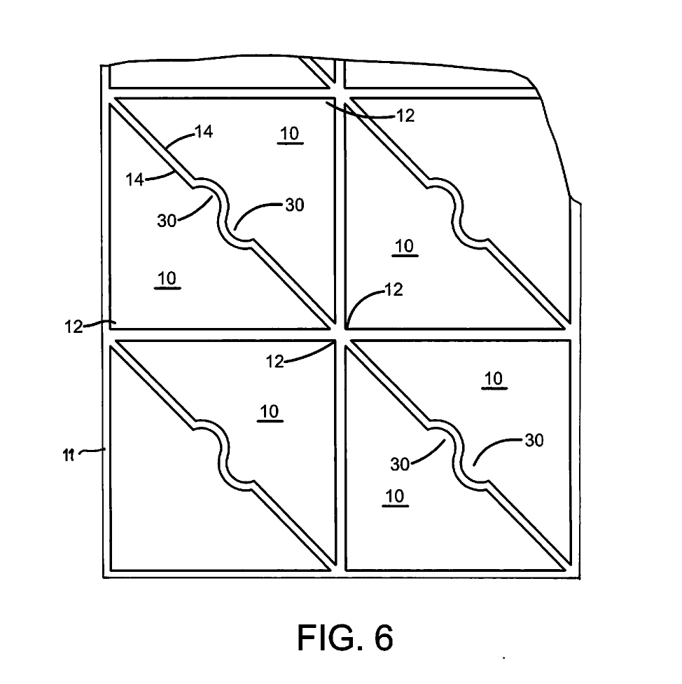

Each masking device depicted in the drawings is indicated generally by the reference numeral 10. Each masking device includes a body having an outer surface and an inner surface with the inner surface carrying a releasable pressure sensitive adhesive that allows the masking device body to be connected to and removed from a surface without depositing adhesive residue. The masking devices 10 are carried on a release liner 11 (FIG. 6). Each masking device 10 is depicted as being generally triangular in shape with two short edges forming a right angle corner 12 and a long back edge 14 defined along the hypotenuse of the triangle. Triangular shapes with right angles are desired because most corners needed masked are in the form of right angles. Masking devices 10 also can be provided in the form of a square or a rectangle.

The edges of each masking device 10 are defined by a kiss cut that extends through the material defining masking device 10 but not through the release liner on which masking devices 10 are disposed prior to use. Masking devices 10 can be made from a paper material that is resistant to latex and oil paint absorption. A coating may be used to limit the absorption of the paint into the paper material of masking device 10. Papers used to fabricate masking tapes can be used. Masking devices 10 also can be made from a polymer sheet material such as polypropylene. A gloss finish can be applied. An example is a 2.61 pt polypropylene material with 0.95 mil gloss laminate. A pressure sensitive adhesive having a lower tack adhesive is secured to the inner surface (the inner surface faces the release liner) of the masking device body material. The adhesive allows the masking device 10 to be secured to a surface and removed without damaging the surface and without depositing a substantial quantity of the adhesive. Suitable adhesives include repositionable pressure sensitive adhesives used with masking tapes. The adhesive can be a natural or synthetic rubber pressure sensitive adhesive or an acrylic pressure sensitive adhesive.

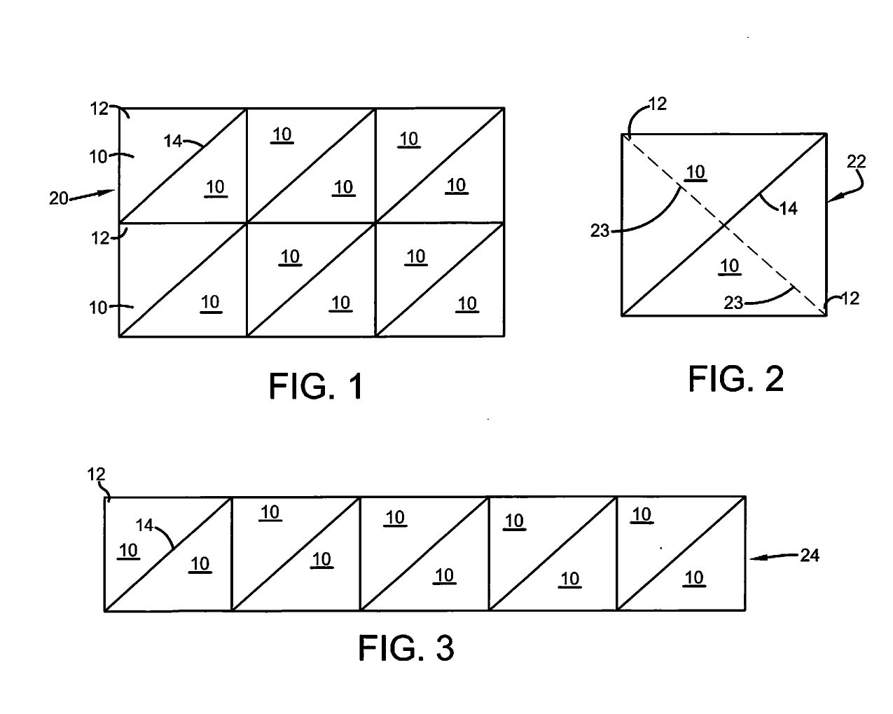

FIG. 1 shows a sheet 20 of masking devices 10. Masking devices 10 are carried on a release liner that is disposed of or recycled after all of the masking devices 10 are removed from the release liner. The long back edges 14 are disposed back-to-back to form masking body squares.

FIG. 2 shows a pair 22 of triangular-shaped masking devices 10. FIG. 2 also depicts a fold line 23 wherein device 10 can be folded to define a mask for a wall corner immediately above a floor or immediately below a ceiling. The corner can be an interior or an exterior corner. Folding masking device 10 along fold line 23 forms two smaller triangles connected at a common short edge with their other disconnected short edges to be disposed against the ceiling or the floor. These folded masks can be used in other locations where two surfaces meet at a corner. Fold line 23 can be provided as a score line in the material of masking device 10 to provide for easy folding. For example, the score line can be formed by removing a portion of the material of masking device 10 along line 23. The score line can be formed by pre-bending the material of masking device 10 along line 23 so that it is readily foldable.

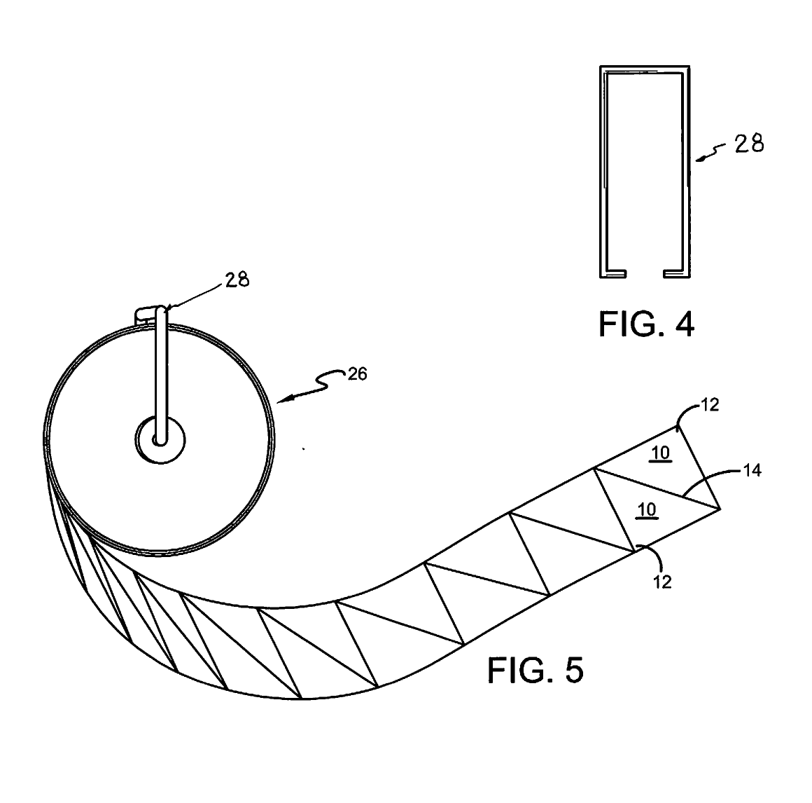

FIG. 3 shows an elongated strip 24 of triangular-shaped masking devices 10. These strips are usually short enough to be stored in a standard folder (less than twelve inches long). The strips also can be formed in long lengths (many feet). These strips can be rolled on themselves to define a rolled strip 26 as shown in FIG. 5. The elongated strips can be rolled with the masking devices 10 facing inwardly or outwardly. Rolled strip 26 can be supported on a wire hanger 28 such as the one depicted in FIG. 4. This hanger 28 rotatably supports roll 26 and can be used to help separate the masking devices 10 from the release liner by allowing the masking devices 10 to be bent over the cross bar of the hanger 28. The cross bar extends from one side of the rolled strip to the other side. The user can pull the strip against the inner surface of the cross bar while peeling the masking devices off of the release liner over the top of the cross bar. The hanger 28 includes legs that extend down to the center of the rolled strip and can be pulled apart to snap a pair of feet into the center of the rolled strip to hold the hanger 28 on the rolled strip.

FIG. 6 depicts four masking devices 10 wherein gripping tabs 30 project from the long back edge 14 of each masking device 10. In this embodiment, each gripping tab 30 is defined by an S-shaped sinusoidal curve in the long back edge 14 such that each long back edge 14 has a concave portion and a convex portion. The sinusoidal curve can be a smoothly curved S-curve as depicted or a squared-off sinusoidal curve that defines rectangular or square gripping tabs 30. The convex portion that extends from the body of masking device 10 defines the gripping tab 30. These gripping tabs help the user remove the masking device 10 from the release liner 11, help the user position the masking device 10 on the surface to be masked, and help the user to remove the masking device from the surface being masked. In one configuration, the gripping tabs 30 may be free of adhesive so that they are easily lifted from the surface being masked when device 10 is being removed. FIG. 6 also depicts a configuration wherein the individual masking bodies are spaced apart on the release liner. These configurations can be use on the sheets or strips described above.

The foregoing description has been made with reference to exemplary embodiments. Modifications and alterations of those embodiments will be apparent to one who reads and understands this general description. The present disclosure should be construed as including all such modifications and alterations insofar as they come within the scope of the appended claims or equivalents thereof.

The relevant portion(s) of any specifically referenced patent and/or published patent application is/are incorporated herein by reference.

1. An adhesive painting mask comprising:
a masking body in the form of a triangle having first and second short edges joined at a right angle and a long back edge disposed at the hypotenuse of the triangle;
the masking body having an inner surface and an outer surface; and
a releasable, pressure sensitive adhesive disposed on the inner surface of the masking body.

2. The mask of claim 1, wherein the masking body is a polymer.

3. The mask of claim 1, wherein the masking body is a paper.

4. The mask of claim 1, wherein a plurality of the masking bodies are disposed on a rolled release liner to form a rolled strip of masks.

5. The mask of claim 4, wherein the rolled strip is carried on a hanger having a cross bar that extends from one side of the rolled strip to another side of the roll.

6. The mask of claim 5, wherein the long back edges of the masking bodies are disposed back-to-back to form masking body squares on the release liner.

7. The mask of claim 6, wherein the long back edges of the masking bodies are spaced apart from each other.

8. The mask of claim 1, wherein a plurality of the masking bodies are disposed on a release liner.

9. The mask of claim 8, wherein the long back edges of the plurality of masking bodies are disposed back-to-back to form a plurality of masking body squares on the release liner.

10. The mask of claim 9, wherein the long back edges of the masking bodies are spaced apart from each other.

11. The mask of claim 9, wherein the masking body squares are spaced from each other.

12. The mask of claim 9, wherein a portion of the long back edge of the masking body projects to define a gripping tab.

13. The mask of claim 12, wherein the gripping tab is disposed between corners of the long back edge with the short edges of the masking body.

14. The mask of claim 12, wherein the gripping tab has an inner surface that is free of adhesive.

15. The mask of claim 12, wherein the gripping tabs are disposed next to each other.

16. The mask of claim 15, wherein the long back edge of the masking body is sinusoidal.

17. The mask of claim 1, wherein a portion of the long back edge of the masking body projects to define a gripping tab.

18. The mask of claim 17, wherein the gripping tab is disposed between corners of the long back edge with the short edges of the masking body.

19. The mask of claim 17, wherein the gripping tab has an inner surface that is free of adhesive.

20. The mask of claim 19, wherein the long back edge of the masking body is sinusoidal.
